(19) United States
(12) Patent Application Publication
(10) Pub. No.: US 2020/0409251 A1
(43) Pub. Date: Dec. 31, 2020

(54) LIGHT SOURCE DEVICE AND IMAGE PROJECTION APPARATUS INCLUDING THE SAME

(71) Applicant: CANON KABUSHIKI KAISHA, Tokyo (JP)

(72) Inventor: Yuuki Maeda, Utsunomiya-shi (JP)

(21) Appl. No.: 16/900,743

(22) Filed: Jun. 12, 2020

(30) Foreign Application Priority Data
Jun. 27, 2019 (JP) 2019-120359

(51) Int. Cl. G03B 21/20; G02B 26/00; G02B 27/14; H04N 9/31

(52) U.S. Cl. CPC G03B 21/2033; G03B 21/2013; G03B 21/2066; H04N 9/3164; G02B 27/141; H04N 9/3158; H04N 9/3161; G02B 26/008

(57) ABSTRACT

A light source device includes a light source unit configured to emit first blue light and second blue light, a rotating wheel including a rotating plate in which a diffuser layer and a phosphor layer are provided, and a condenser lens. The rotating plate is configured to reflect light incident on the diffuser layer and also reflect light incident on the phosphor layer, and the condenser lens is configured so that the first blue light is incident on the diffuser layer via a first area, and the light from the diffuser layer is incident on a second area.

### BACKGROUND OF THE INVENTION

### Field of the Invention

The present invention relates to a light source device and an image projection apparatus including the same.

### Description of the Related Art

As a light source device for a projector (an image projection apparatus), a light source device discussed in Japanese Patent Application Laid-Open No. 2018-124445 is known. The light source device discussed in Japanese Patent Application Laid-Open No. 2018-124445 includes a first rotating wheel having a wavelength conversion element, and a second rotating wheel having a diffusion element. The light source device also includes a first blue laser diode (hereinafter, “blue LD”) that emits blue light to be incident on the first rotating wheel, and a second blue LD that emits blue light to be incident on the second rotating wheel.

In the light source device discussed in Japanese Patent Application Laid-Open No. 2018-124445, blue light from the first blue LD is diffusely reflected by the first rotating wheel and wavelength-converted into yellow light, and the yellow light is projected onto a screen through a liquid crystal panel at the subsequent stage. Blue light from the second blue LD diffusely passes through the second rotating wheel and is projected as the blue light onto the screen through the liquid crystal panel at the subsequent stage.

In the light source device discussed in Japanese Patent Application Laid-Open No. 2018-124445, since two rotating members, namely the first and second rotating wheels, exist, two motors for rotating the rotating wheels also exist. Thus, the light source device discussed in Japanese Patent Application Laid-Open No. 2018-124445 becomes large due to the existence of the two rotating wheels and the two motors. If the light source device becomes large, the projector also becomes large, which is not desirable.

### SUMMARY OF THE INVENTION

According to an aspect of the present invention, a light source device that guides light to an illumination optical system for illuminating a light modulation element includes a light source unit configured to emit first blue light and second blue light, a rotating wheel including a rotating plate in which a diffusion element on which the first blue light is incident and a wavelength conversion element on which the second blue light is incident are provided, and a first condenser lens unit configured to guide the first blue light to the diffusion element, wherein the rotating plate is configured to reflect light incident on the diffusion element and also reflect light incident on the wavelength conversion element, and wherein the first condenser lens unit is configured so that the first blue light from the light source unit is incident on the diffusion element via a first area of the first condenser lens unit, and the light from the diffusion element is incident on a second area of the first condenser lens unit.

According to another aspect of the present invention, a light source device that guides light to an illumination optical system for illuminating a light modulation element includes a light source unit configured to emit first blue light and second blue light, a rotating wheel including a rotating plate in which a diffusion element on which the first blue light is incident and a wavelength conversion element on which the second blue light is incident are provided, and a first condenser lens unit configured to guide the first blue light to the diffusion element, wherein the rotating plate is configured to reflect light incident on the diffusion element and also reflect light incident on the wavelength conversion element, wherein the first condenser lens unit is placed so that an optical axis of the first condenser lens unit is at an angle to a normal to the rotating wheel, and wherein the first blue light from the light source unit is incident on the diffusion element via the first condenser lens unit, and the light from the diffusion element is guided to the illumination optical system not via the first condenser lens unit.

Further features of the present invention will become apparent from the following description of exemplary embodiments with reference to the attached drawings.

### BRIEF DESCRIPTION OF THE DRAWINGS

FIG. 1 is a diagram illustrating a configuration of a projector including a light source device according to each of exemplary embodiments.

FIG. 2 is a diagram illustrating a configuration of a light source device according to a first exemplary embodiment.

FIG. 3 is a diagram illustrating an incident position and an emission position of light in a condenser lens.

FIG. 4 is a diagram illustrating a configuration of a rotating wheel included in the light source device according to each exemplary embodiment.

FIG. 5 is a diagram illustrating a configuration of a light source device according to a second exemplary embodiment.

FIG. 6 is a diagram illustrating a configuration of a light source device according to a third exemplary embodiment.

FIG. 7 is a diagram illustrating a configuration of a light source device according to a fourth exemplary embodiment.

FIG. 8 is a diagram illustrating prism mirrors applicable to each exemplary embodiment.

### DESCRIPTION OF THE EMBODIMENTS

### Configuration of Projector

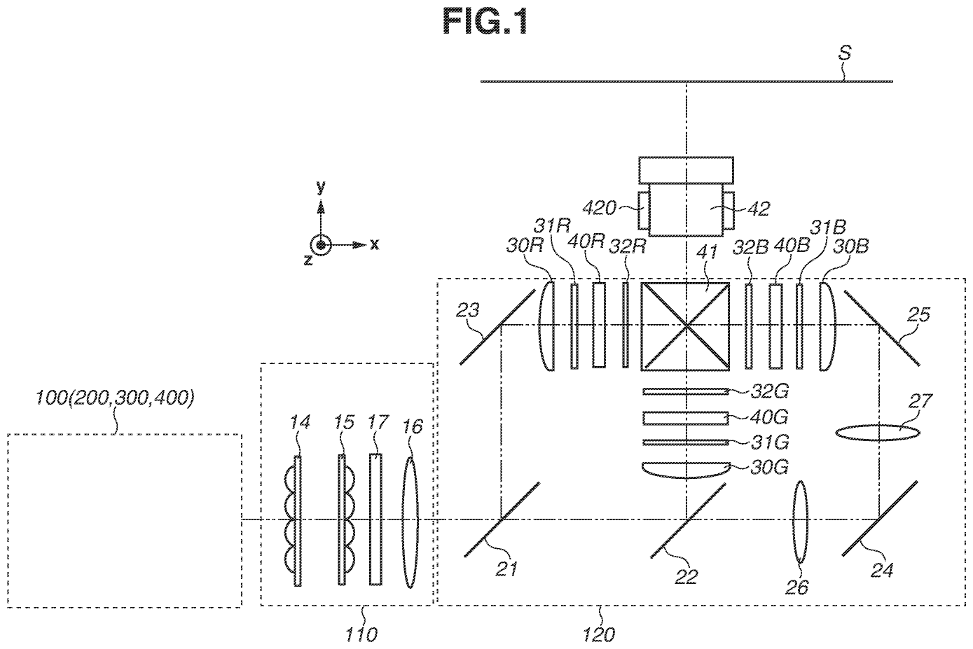

With reference to FIG. 1, a description is given of a projector in which a light source device according to each of exemplary embodiments can be installed.

In a first exemplary embodiment, a projector illustrated in FIG. 1 includes a light source device 100, an illumination optical system 110, a color separating/combining unit 120, a projection lens 42, and a lens holding unit 420 capable of holding the projection lens 42. Instead of the light source device 100, any of a light source device 200 according to a second exemplary embodiment, a light source device 300 according to a third exemplary embodiment, and a light source device 400 according to a fourth exemplary embodiment may be used.

White light emitted from the light source device 100 is projected onto a screen S via the illumination optical system 110, the color separating/combining unit 120, and the projection lens 42.

The light source device according to each exemplary embodiment can be mounted on not only a front projector that projects an image from the front side of a screen, but also a rear projector that projects an image from the back side of a screen, so long as the projector can project an image onto the screen (projection target surface) S.

The projection lens 42 may be an interchangeable lens that can be detached from the lens holding unit 420, or may be a fixed lens that cannot be detached from the lens holding unit 420.

### Configuration of Illumination Optical System 110

The illumination optical system 110 includes a first lens array 14, a second lens array 15, a polarization conversion element 17, and a condenser lens 16 that are placed in order from the light source device 100 side.

The first lens array 14 includes a plurality of lens cells that is arranged in a matrix in a plane orthogonal to the optical axis of the illumination optical system 110 and divides light from the light source device 100 into a plurality of beams.

The second lens array 15 includes a plurality of lens cells arranged in a matrix in a plane orthogonal to the optical axis of the illumination optical system 110 in a corresponding manner to the plurality of lens cells of the first lens array 14. The second lens array 15 and the condenser lens 16 form images of the plurality of lens cells of the first lens array 14 near light modulation elements 40R, 40G, and 40B.

Between the second lens array 15 and the condenser lens 16, the polarization conversion element 17 is placed. The polarization conversion element 17 is configured to align the polarization direction of the light from the light source device 100 in a predetermined direction.

The condenser lens 16 condenses the plurality of divided beams from the second lens array 15 and superimposes the condensed light on the light modulation elements 40R, 40G, and 40B. In other words, the first lens array 14, the second lens array 15, and the condenser lens 16 form an integrator optical system that uniformizes the intensity distribution of the light from the light source device 100. The integrator optical system may be an optical system using a rod integrator.

### Configuration of Color Separating/Combining Unit 120

The color separating/combining unit 120 consists of a color separating/combining system and the light modulation elements 40R, 40G, and 40B. The color separating/combining system consists of optical elements described below. In FIG. 1, the light modulation elements 40R, 40G, and 40B are transmissive liquid crystal panels. Alternatively, instead of the transmissive liquid crystal panels, reflective liquid crystal panels or micromirror arrays can also be used. Thus, the configuration of the color separating/combining system may be appropriately changed depending on the types of light modulation elements. Although a total of three light modulation elements exist in FIG. 1, the light source device according to each exemplary embodiment can also be mounted on a projector including one or two light modulation elements. In a case where a single light modulation element is included, the color separating/combining system is not necessary.

White light from the illumination optical system 110 is color-separated by a dichroic mirror 21. The dichroic mirror 21 has the property of reflecting red light and transmitting blue light and green light.

### Optical Path of Red Light

Red light from the dichroic mirror 21 is reflected by a mirror 23 and incident on the red-light light modulation element 40R via a condenser lens 30R and an incident-side polarizing plate 31R. Based on information from an input device of a computer connected to the projector, the red-light light modulation element 40R modulates the incident red light. The red light modulated by the red-light light modulation element 40R is projected onto the screen S via an emission-side polarizing plate 32R, a cross dichroic prism 41, and the projection lens 42. The cross dichroic prism 41 has a cube or cuboid shape obtained by bonding four right angle prisms together, and dichroic films as dielectric multilayer films are formed on the surfaces on which the prisms are bonded together.

### Optical Path of Green Light

Green light from the dichroic mirror 21 is incident on a dichroic mirror 22. The dichroic mirror 22 has the property of reflecting green light and transmitting blue light. The green light from the dichroic mirror 22 is incident on the green-light light modulation element 40G via a condenser lens 30G and an incident-side polarizing plate 31G. Similarly to the red-light light modulation element 40R, based on information from the input device, the green-light light modulation element 40G also modulates the incident green light. The green light modulated by the green-light light modulation element 40G is projected onto the screen S via an emission-side polarizing plate 32G, the cross dichroic prism 41, and the projection lens 42.

### Optical Path of Blue Light

Blue light from the dichroic mirror 21 is incident on the dichroic mirror 22. As described above, the dichroic mirror 22 has the property of reflecting green light and transmitting blue light. Thus, the blue light from the dichroic mirror 21 passes through the dichroic mirror 22 and is incident on the blue-light light modulation element 40B via a relay optical system, a condenser lens 30B, and an incident-side polarizing plate 31B. The “relay optical system” refers to a relay lens 26, a mirror 24, a relay lens 27, and a mirror 25.

Similarly to the red-light light modulation element 40R, based on information from the input device, the blue-light light modulation element 40B also modulates the incident blue light. The blue light modulated by the blue-light light modulation element 40B is projected onto the screen S via an emission-side polarizing plate 32B, the cross dichroic prism 41, and the projection lens 42.

The red light, the green light, and the blue light are projected onto the screen S via the above optical paths, thereby displaying a color image.

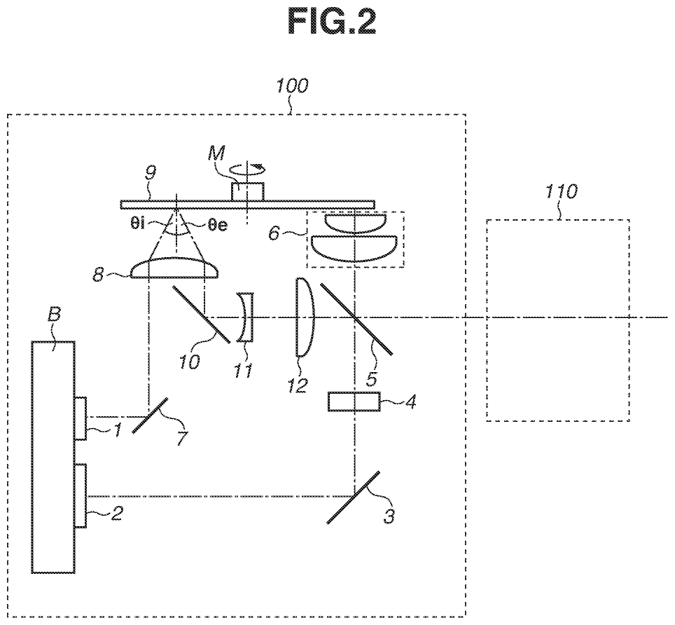

The light source device 100 according to the first exemplary embodiment is described with reference to FIGS. 2 to 4.

FIG. 2 is a diagram illustrating the configuration of the light source device 100. FIG. 2 illustrates a first light source unit 1 that emits blue light, and a second light source unit 2 that emits blue light. The blue light (first blue light) from the first light source unit 1 is guided to a diffuser layer (diffusion element) 9C, and the blue light (second blue light) from the second light source unit 2 is guided to a phosphor layer (wavelength conversion element) 9B.

Each of the first light source unit 1 and the second light source unit 2 is a single blue laser diode (LD) (light-emitting device) or a set of blue LDs (a blue LD bank) held by the same member. In the first, second, and third exemplary embodiments, the first light source unit 1 is a single blue LD bank, and the second light source unit 2 is two blue LD banks placed close to (in contact with) each other. A single blue LD bank includes a total of eight blue LDs, eight collimator lenses for converting light diverging from the blue LDs into parallel light, and a holding member that holds the plurality of blue LDs and the plurality of collimator lenses. Then, on a base member B, the blue LD bank as the first light source unit 1 is provided at a position away from the set of the two blue LD banks as the second light source unit 2.

The number and the wavelength of blue LDs of the first light source unit 1 may be the same as or different from the number and the wavelength of blue LDs of the second light source unit 2. The wavelength of blue light from a blue LD used in the present exemplary embodiment is 445 nm. Alternatively, a blue LD that emits blue light of 455 nm or 465 nm may be used. In the present exemplary embodiment, the number of blue LDs included in the first light source unit 1 is smaller than the number of blue LDs included in the second light source unit 2. Alternatively, the relationship between the numbers of blue LDs may be reversed, or the numbers of blue LDs may be the same.

The first light source unit 1 and the second light source unit 2 are both provided on the base member B. The base member B includes a heat dissipation unit such as a plurality of fins for dissipating heat generated by the first light source unit 1 and the second light source unit 2.

The first light source unit 1 and the second light source unit 2 may be distinguished from each other as follows. In a case where a plurality of blue LD banks is provided on the base member B, a blue LD bank that emits light to be incident on a condenser lens (first condenser lens unit) 8 among the plurality of blue LD banks is the first light source unit 1. In a case where there is a plurality of blue LD banks that emits light to be incident on the condenser lens 8, the plurality of blue LD banks is the first light source unit 1. Similarly, a blue LD bank that emits light to be incident on a condenser lens unit 6 among the plurality of blue LD banks provided on the base member B is the second light source unit 2. In a case where there is a plurality of blue LD banks that emits light to be incident on the condenser lens unit (second condenser lens unit) 6, the plurality of blue LD banks is the second light source unit 2.

### Optical Path of Blue Light from First Light Source Unit 1

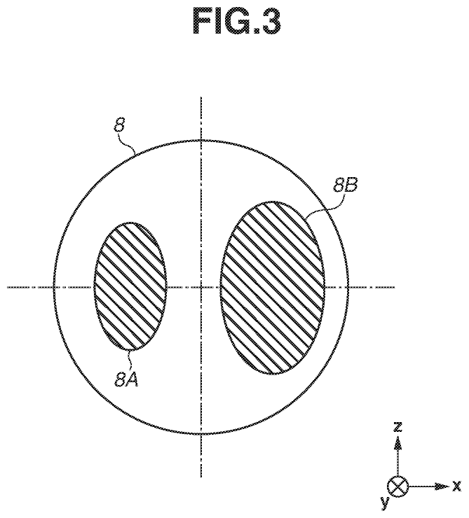

The blue light (blue parallel light) from the first light source unit 1 is reflected by a mirror 7. As illustrated in FIGS. 2 and 3, the blue light reflected by the mirror 7 is incident on an area (first area) 8A of the condenser lens 8 shifted to the opposite side of the rotation shaft of a rotating wheel 9 with respect to the optical axis of the condenser lens 8. The light incident on the condenser lens 8 is condensed on the diffuser layer (diffusion element) 9C of the rotating wheel 9 by the condenser lens 8.

As illustrated in FIGS. 2 and 3, the blue light diffused by the diffuser layer 9C is incident on an area (second area) 8B of the condenser lens 8 shifted to the rotation shaft side based on the rotation shaft of the rotating wheel 9 with respect to the optical axis of the condenser lens 8.

That is, the single condenser lens 8 lets in not only light to be incident on the diffuser layer 9C but also emitted light diffused by the diffuser layer 9C. Thus, it is possible to reduce the number of lenses and downsize the light source device 100.

Although the details will be described below, the phosphor layer 9B converts the wavelength (color) of light incident on the phosphor layer 9B. Thus, using a dichroic mirror (combining element) 5, it is possible to make blue light incident on the phosphor layer 9B and also guide yellow light from the phosphor layer 9B to the illumination optical system 110. That is, the optical path of light incident on the phosphor layer 9B and the optical path of light emitted from the phosphor layer 9B are differentiated from each other using the dichroic mirror 5. On the other hand, the diffuser layer 9C merely diffuses light incident on the diffuser layer 9C, and does not convert the wavelength of the incident light. Thus, there is no point in placing a dichroic mirror before the diffuser layer 9C. Accordingly, in the present exemplary embodiment, as illustrated in FIG. 3, the area 8A where light to be incident on the diffuser layer 9C passes through the condenser lens 8 and the area 8B where light emitted from the diffuser layer 9C passes through the condenser lens 8 are differentiated from each other. This separates the path of light incident on the diffuser layer 9C and the path of light emitted from the diffuser layer 9C from each other.

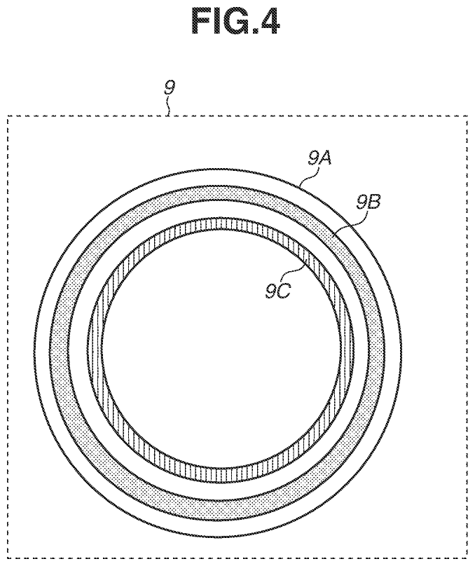

As illustrated in FIG. 4, the rotating wheel 9 has a configuration in which the annular phosphor layer (wavelength conversion element) 9B and the annular diffuser layer 9C are formed as concentric circles on the surface of the rotating plate 9A.

The rotating plate 9A is made of a metal such as aluminum. The rotating plate 9A, however, is not limited to this configuration so long as light incident on the phosphor layer 9B and the diffuser layer 9C can be sufficiently reflected for use. The phosphor layer 9B is provided outside the diffuser layer 9C. Conversely, the phosphor layer 9B may be provided inside the diffuser layer 9C.

In the present exemplary embodiment, since the diffuser layer and the phosphor layer are formed on the same rotating wheel, a single rotating wheel may be provided, and a single rotation support mechanism and a single motor M for the rotating wheel may be provided. Thus, it is possible to achieve significant downsizing from a configuration in which a wavelength conversion element and a diffusion element are formed on separate rotating wheels as in a conventional technique.

The diffuser layer 9C is formed by, for example, applying, to the rotating plate 9A, a product obtained by uniformly mixing fine diffusing particles with a transparent resin binder. The diffuser layer 9C, however, is not limited to the above configuration so long as incident light can be diffused to the extent that the diffused light can be properly used.

The blue light incident on the diffuser layer 9C from the condenser lens 8 is diffusely reflected by the diffuser layer 9C and the rotating plate 9A, is converted into parallel light by the condenser lens 8, and travels to a mirror 10. At this time, the blue light is incident on the area 8B of the condenser lens 8. In the present exemplary embodiment, the condenser lens 8 consists of a single positive lens. Alternatively, the condenser lens 8 may consist of a set of a plurality of lenses so long as the entire configuration has positive power.

The blue light reflected by the mirror 10 is incident on the dichroic mirror 5 via an afocal optical system (an afocal lens unit) consisting of a negative lens 11 and a positive lens 12 and is enlarged into parallel light having a larger diameter. The reason for using the afocal optical system is as follows.

The blue light from the second light source unit 2 is diffused by the phosphor layer 9B, and the blue light from the first light source unit 1 is diffused by the diffuser layer 9C. The degree of diffusion by the phosphor layer 9B is greater than the degree of diffusion by the diffuser layer 9C. This is because the diffuser layer 9C only needs to diffuse blue light from a blue LD that is laser light having coherence to the extent that the diffused blue light can be properly used. If the degree of diffusion by the diffuser layer 9C is greater than necessary, the diameter of the condenser lens 8 becomes larger than necessary, and the light source device 100 becomes large, which is not desirable.

That is, the diameter of blue parallel light from the condenser lens 8 is smaller than the diameter of yellow parallel light from the condenser lens unit 6.

If blue light and yellow light having different diameters from each other are guided to the light modulation elements 40R, 40G, and 40B via the illumination optical system 110, color unevenness occurs in the projected image, which is not desirable. Accordingly, in the present exemplary embodiment, the diameter of the blue parallel light from the condenser lens 8 is made large using an afocal optical system capable of making a diameter large, thereby making the difference between the diameter of the blue parallel light from the condenser lens 8 and the diameter of the yellow parallel light from the condenser lens unit 6 small. The afocal optical system is not limited to the above configuration so long as the afocal optical system can convert parallel light incident on the afocal optical system into parallel light having a larger diameter. For example, an afocal optical system consisting of a total of three or more lenses may be used.

The dichroic mirror 5 has the property of transmitting blue light and reflecting yellow light (red light and green light). Thus, the blue light from the positive lens 12 passes through the dichroic mirror 5 and is guided to the illumination optical system 110. The optical path from the illumination optical system 110 is as described above.

### Optical Path of Blue Light from Second Light Source Unit 2

The blue light (blue parallel light) from the second light source unit 2 is condensed on the phosphor layer 9B via a mirror 3, a microlens array 4, the dichroic mirror 5, and the condenser lens unit 6. The microlens array 4 is an optical element in which a plurality of lens arrays is placed in a matrix on its incident side and emission side. The blue light from the mirror 3 is divided into a plurality of partial beams by the microlens array 4, and the plurality of partial beams is superimposed on the phosphor layer 9B by the condenser lens unit 6. Since the dichroic mirror 5 has the property of transmitting blue light as described above, the blue light from the microlens array 4 passes through the dichroic mirror 5 and is incident on the condenser lens unit 6. Alternatively, instead of the microlens array 4, a rod integrator or, for example, a light diffusion element having a concavo-convex structure may be used.

In the present exemplary embodiment, the condenser lens unit 6 consists of two positive lenses. Alternatively, a single positive lens or a set of a plurality of lenses may be used instead of the condenser lens unit 6 so long as the entire configuration has positive power.

The phosphor layer 9B is formed by applying, to the rotating plate 9A, a product obtained by uniformly mixing fine phosphor particles with a transparent resin binder. The phosphor layer 9B, however, is not limited to the above configuration so long as incident light can be diffused to the extent that the diffused light can be properly used, and blue light can also be sufficiently converted into yellow light. For example, instead of the phosphor layer 9B, a quantum dot or a quantum rod may be used.

The blue light incident on the phosphor layer 9B from the condenser lens unit 6 is converted into yellow light by the above phosphor particles, and the yellow light is reflected by the rotating plate 9A and incident on the condenser lens unit 6. The yellow light incident on the condenser lens unit 6 from the phosphor layer 9B is converted into parallel light, reflected by the dichroic mirror 5, and guided to the illumination optical system 110. Consequently, the light source device 100 can emit blue light and yellow light, i.e., white light. Then, since both the diffuser layer 9C and the phosphor layer 9B are formed on the common rotating wheel 9, it is possible to downsize a light source device more significantly than in a conventional technique.

### Settings of Optical Systems

Specific examples of optical systems are described.

The light source device 100 satisfies

1.2≤f1/f2≤10 (1),

where the focal length of the condenser lens 8 is f1, and the focal length of the condenser lens unit 6 is f2.

Alternatively, the light source device 100 satisfies

2.0≤f1/f2<6.0 (1a).

In the present exemplary embodiment, f1/f2=4.0.

In condition inequalities (1) and (1a), the focal length f1 is greater than the focal length f2. This means that the power of the condenser lens 8 is weaker than the power of the condenser lens unit 6. The effects obtained by the light source device 100 satisfying the condition inequality (1) or (1a) are as follows.

In a case where the focal length f1 is so small as to deviate from the lower limit of condition inequality (1) (where the power of the condenser lens 8 is too strong), if the power of the condenser lens 8 is too strong, the blue light incident on the condenser lens 8 from the mirror 7 is strongly bent by the condenser lens 8 and incident on the diffuser layer 9C. That is, the angle of incidence of the blue light on the diffuser layer 9C becomes great. If the angle of incidence of the blue light on the diffuser layer 9C becomes great, the angle of emission (the angle of reflection) of the blue light from the diffuser layer 9C also becomes great. Then, a part of the blue light from the diffuser layer 9C is not incident on the condenser lens 8, does not proceed along a desired optical path, and is not guided to the illumination optical system 110. This results in increasing loss. If the condenser lens 8 is made large in the radial direction to reduce such loss, the light source device 100 becomes large.

Conversely, in a case where the focal length f1 deviates from the upper limit of condition inequality (1), i.e., if the power of the condenser lens 8 is too weak, the blue light incident on the condenser lens 8 from the mirror 7 is not sufficiently bent, and the angle of incidence of the blue light on the diffuser layer 9C becomes small. As a result, the angle of emission (the angle of reflection) of the blue light from the diffuser layer 9C also becomes small. This means that the areas 8A and 8B illustrated in FIG. 3 come close to each other, i.e., the mirrors 7 and 10 come close to each other.

If a part of the mirror 7 and a part of the mirror 10 come so close as to overlap each other when viewed in the direction of the optical axis of the condenser lens 8, a part of the blue light from the mirror 7 is rejected by the mirror 10, and is not incident on the condenser lens 8. As a result, the part of the blue light is not guided to the illumination optical system 110, which is loss.

As described above, the focal length f1 is set so that the light source device 100 satisfies condition inequality (1) or (1a), whereby it is possible to prevent the condenser lens 8 and the light source device 100 from becoming large and also reduce loss.

The light source device 100 satisfies

5°≤θi≤45° (2)

where the angle of incidence of the blue light incident on the diffuser layer 9C from the condenser lens 8 is θi.

Alternatively, the light source device 100 satisfies

10°≤θi≤30° (2a).

In the present exemplary embodiment, θi=20°. If the first light source unit 1 includes only a single blue LD, the angle of incidence of a ray emitted from the center point of the light emission surface of the blue LD on the diffuser layer 9C is θi. If the first light source unit 1 includes a plurality of blue LDs, the angle of incidence of a ray passing through the optical axis of a lens (not illustrated in FIG. 2) for condensing light from the plurality of blue LDs on the diffuser layer 9C is θi. Alternatively, the angle of incidence of a ray emitted from the center point of the mirror 7 on the diffuser layer 9C is θi.

Condition inequalities (2) and (2a) mean that the angle of incidence θi on the diffuser layer 9C is not too small and not too great. The effects obtained by the light source device 100 satisfying condition inequality (2) or (2a) are as follows.

If the angle of incidence θi is so small as to deviate from the lower limit of condition inequality (2), the angle of emission (the angle of reflection) θe of the blue light from the diffuser layer 9C also becomes small. Thus, loss occurs due to the fact that the mirrors 7 and 10 are too close to each other. Conversely, if the angle of incidence θi is so great as to deviate from the upper limit of condition inequality (2), the angle of emission θe also becomes great. Thus, loss occurs due to the fact that a part of the blue light from the diffuser layer 9C is not incident on the condenser lens 8, or there is no choice but to make the diameter of the condenser lens 8 large.

As described above, the angle of incidence θi is set so that the light source device 100 satisfies condition inequality (2) or (2a), whereby it is possible to prevent the condenser lens 8 and the light source device 100 from becoming large and also reduce the loss of light.

The light source device 100 satisfies

1°≤Φ≤30° (3)

where the diffusion angle of the diffuser layer 9C is Φ.

Alternatively, the light source device 100 satisfies

1°≤Φ≤15° (3a)

In the present exemplary embodiment, Φ=10°. The diffusion angle Φ may be measured as follows. A measurement position may be set at a position corresponding to half the distance in the direction of the optical axis of the condenser lens 8 between the surface of the diffuser layer 9C (or the surface of the rotating plate 9A) and the vertex of the surface on the rotating wheel 9 side of the condenser lens 8. The illuminance distribution of light emitted from the diffuser layer 9C at the measurement position may be measured, and the full width at half maximum of the illuminance distribution may be calculated. Then, the angle between a total of three points including two points corresponding to end portions of the full width at half maximum and the center point of the diffuser layer 9C in the radial direction may be set as the diffusion angle Φ.

Condition inequalities (3) and (3a) mean that the diffusion angle Φ of the diffuser layer 9C is not too small and not too great. The effects obtained by the light source device 100 satisfying condition inequality (3) or (3a) are as follows.

If the diffusion angle Φ is so small as to deviate from the lower limit of condition inequality (3), this means that light from a blue LD included in the first light source unit 1 is not sufficiently diffused by the diffuser layer 9C. If the light from the blue LD that is laser light having coherence is not sufficiently diffused, speckle noise (an unnecessary pattern such as a light and dark speckled pattern) is likely to be visually recognized on the screen S. Conversely, if the diffusion angle Φ is so great as to deviate from the upper limit of condition inequality (3), this means that the light from the blue LD included in the first light source unit 1 is excessively diffused by the diffuser layer 9C. If the light from the blue LD is excessively diffused by the diffuser layer 9C, the above speckle noise is reduced, but the light from the diffuser layer 9C spreads more than in the present exemplary embodiment. As a result, loss occurs due to the fact that a part of the blue light from the diffuser layer 9C is not incident on the condenser lens 8, or there is no choice but to make the diameter of the condenser lens 8 large.

As described above, the diffusion angle Φ is set so that the light source device 100 satisfies condition inequalities (3) or (3a), whereby it is possible to reduce speckle noise, prevent the condenser lens 8 and the light source device 100 from becoming large, and also reduce the loss of light.

The light source device 100 according to the present exemplary embodiment satisfies all the above condition inequalities. It is, however, not essential for the light source device 100 to satisfy all the above condition inequalities. The light source device 100 may satisfy any one or more of the above condition inequalities. For example, the light source device 100 may satisfy condition inequalities (1) and (2), but may not satisfy condition inequality (3). A light source device satisfying both condition inequalities (1) and (1a) can obtain the above effects more strongly than a light source device satisfying condition inequality (1). The same applies to condition inequalities (2) and (2a) and the like.

As described above, the light source device 100 includes the afocal optical system consisting of the negative lens 11 and the positive lens 12. The afocal optical system, however, is not essential. If the diameter of parallel light traveling from the condenser lens 8 to the mirror 10 is brought sufficiently close to the diameter of parallel light traveling from the collimator lens unit to the dichroic mirror 5 by adjusting the diffusion angle Φ and the focal length f2, the afocal optical system may not be included.

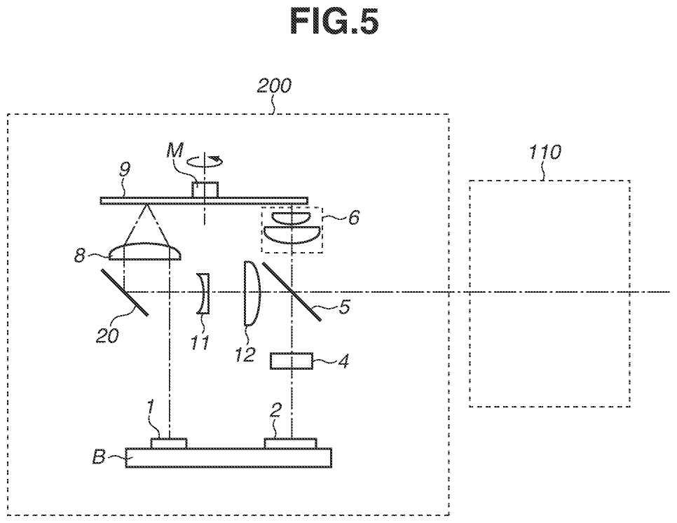

The light source device 200 according to the second exemplary embodiment is described with reference to FIG. 5. The light source device 100 according to the first exemplary embodiment and the light source device 200 according to the present exemplary embodiment are mainly different from each other in the number of mirrors and in that the position where the blue light from the first light source unit 1 is incident on the condenser lens 8.

### Optical Path of Blue Light from First Light Source Unit 1

The optical path of the blue light from the first light source unit 1 according to the present exemplary embodiment is described. The blue light (parallel light) from the first light source unit 1 is incident on an area on the incident surface (the surface on the opposite side of the surface on the rotating wheel 9 side) of the condenser lens 8 and on the negative lens 11 side with respect to the optical axis of the condenser lens 8. In the light source device 100 according to the first exemplary embodiment, contrary to the present exemplary embodiment, the blue light from the first light source unit 1 is incident on the area on the incident surface of the condenser lens 8 and on the opposite side of the negative lens 11 side with respect to the optical axis of the condenser lens 8.

If an attempt is made to make the blue light from the first light source unit 1 incident on a position similar to that in the first exemplary embodiment, it is necessary to move the position of the first light source unit 1 illustrated in FIG. 5 to the left on the plane of the paper in FIG. 5. Then, if the position of the first light source unit 1 is moved to the left on the plane of the paper in FIG. 5, it is necessary to make the base member B large accordingly. That is, the light source device 200 according to the present exemplary embodiment is smaller than the light source device 100 according to the first exemplary embodiment.

The blue light incident on the diffuser layer 9C from the first light source unit 1 via the condenser lens 8 is diffusely reflected by the diffuser layer 9C and the rotating plate 9A and incident on a mirror 20 via the condenser lens 8. The blue light reflected by the mirror 20 is guided to the illumination optical system 110 via the negative lens 11, the positive lens 12, and the dichroic mirror 5.

### Optical Path of Blue Light from Second Light Source Unit 2

The blue light from the second light source unit 2 according to the present exemplary embodiment is guided to the illumination optical system 110 not via the mirror 3 of the light source device 100 according to the first exemplary embodiment. Other portions of the optical path are similar to those in the first exemplary embodiment, and therefore are not described here.

As described above, the light source device 200 according to the present exemplary embodiment can make the number of mirrors smaller than the light source device 100 according to the first exemplary embodiment and also make the base member B small, which is desirable.

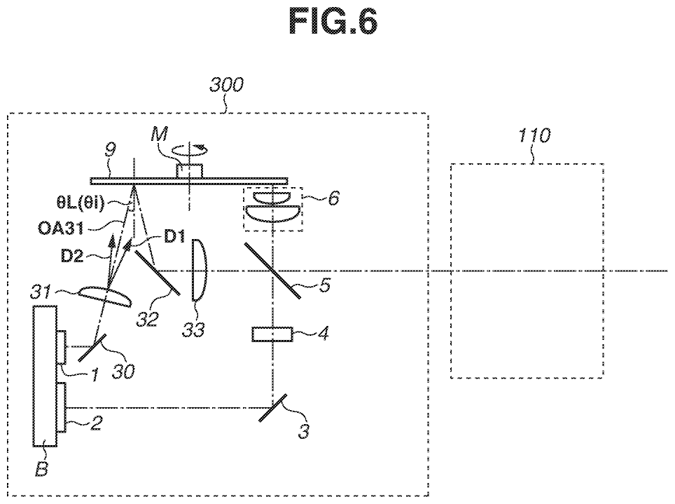

The light source device 300 according to the third exemplary embodiment is described with reference to FIG. 6. The light source device 100 according to the first exemplary embodiment and the light source device 300 according to the present exemplary embodiment are mainly different from each other in the configuration of a condenser lens provided between the first light source unit 1 and the diffuser layer 9C. The light source device 100 and the light source device 300 are also different from each other in that the afocal optical system consisting of the negative lens 11 and the positive lens 12 is not included in the light source device 300. However, the afocal optical system consisting of the negative lens 11 and the positive lens 12 may be added to the light source device 300.

### Optical Path of Blue Light from First Light Source Unit 1

The blue light (parallel light) from the first light source unit 1 is reflected by a mirror 30 and incident on a condenser lens 31. The condenser lens 31 condenses the blue parallel light from the mirror 30 on the diffuser layer 9C.

In the first and second exemplary embodiments, the blue light from the first light source unit 1 is incident on one of the areas to the left and right of (or above and below) the optical axis of the condenser lens 8, and the blue light from the diffuser layer 9C is incident on the other area. In contrast, in the present exemplary embodiment, the blue light from the first light source unit 1 is incident on an area including the optical axis of the condenser lens 31, and the blue light from the diffuser layer 9C is not incident on the condenser lens 31. That is, in the present exemplary embodiment, the condenser lens provided between the first light source unit 1 and the diffuser layer 9C can be made smaller in the radial direction than in the first and second exemplary embodiments, which is desirable.

The blue light from the diffuser layer 9C is reflected by a mirror 32, converted into parallel light by a collimator lens 33, and guided to the illumination optical system 110 via the dichroic mirror 5.

The light source device 300 satisfies

0.9≤θL/θi≤1.1 (4)

where the angle between a normal to the rotating wheel 9 and an optical axis OA31 of the condenser lens 31 is θL, and the angle of incidence of the blue light incident on the diffuser layer 9C from the condenser lens 31 is θi.

Condition inequality (4) means that the traveling direction of the blue light traveling from the condenser lens 31 to the diffuser layer 9C substantially coincides with the optical axis of the condenser lens 31. In the present exemplary embodiment, θL/θi=1.0. Possible examples of a case where θi is so much greater than θL as to deviate from the lower limit of condition inequality (4) include a case where the blue light from the condenser lens 31 proceeds in a direction D1 tilted to the right of the optical axis OA31 on the plane of the paper in FIG. 6. In this case, the blue light from the condenser lens 31 is likely to interfere with the mirror 32, which is not desirable. Conversely, possible examples of a case where θi is so much smaller than θL as to deviate from the upper limit of condition inequality (4) include a case where the blue light from the condenser lens 31 proceeds in a direction D2 tilted to the left of the optical axis OA31 on the plane of the paper in FIG. 6. In this case, the position of the diffuser layer 9C needs to be set further outside. This makes the rotating wheel 9 large in the radial direction, which is not desirable.

### Optical Path of Blue Light from Second Light Source Unit 2

The optical path of the blue light from the second light source unit 2 is similar to that in the first exemplary embodiment, and therefore is not described here.

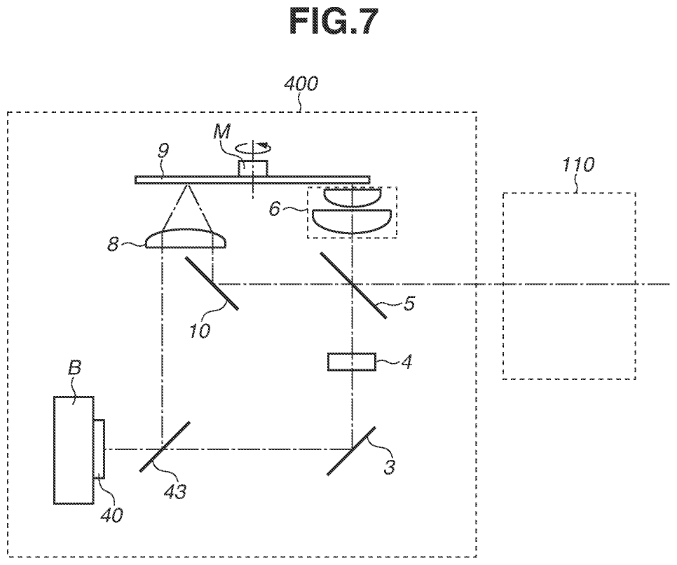

The light source device 400 according to the fourth exemplary embodiment is described with reference to FIG. 7. The light source device 100 according to the first exemplary embodiment and the light source device 400 according to the present exemplary embodiment are mainly different from each other in the configuration of a light source unit and in that a half mirror is used in the light source device 400. The light source device 100 and the light source device 400 are also different from each other in that the afocal optical system consisting of the negative lens 11 and the positive lens 12 is not included in the light source device 400. However, the afocal optical system consisting of the negative lens 11 and the positive lens 12 may be added to the light source device 400.

### Optical Path of Blue Light from Light Source Unit 40

A light source unit 40 includes as many blue LDs as the total of the number of blue LDs included in the first light source unit 1 and the number of blue LDs included in the second light source unit 2. Blue light from the light source unit 40 is incident on a half mirror 43 (a separating unit). The transmittance of blue light through the half mirror 43 is 80%. That is, 80% of the blue light from the light source unit 40 passes through the half mirror 43 and is incident on the phosphor layer 9B via the mirror 3, the microlens array 4, and the condenser lens unit 6. Meanwhile, the remaining 20% is reflected by the half mirror 43 and incident on the diffuser layer 9C via the condenser lens 8. As described above, the half mirror 43 functions as a separating unit for separating the blue light from the light source unit 40 into first blue light and second blue light. The optical path of the blue light incident on the diffuser layer 9C and the optical path of the blue light incident on the phosphor layer 9B are almost similar to those in the first exemplary embodiment, and therefore are not described here.

In the first to third exemplary embodiments, the light source unit that emits blue light to be incident on the diffuser layer 9C and the light source unit that emits blue light to be incident on the phosphor layer 9B are separately provided at positions away from each other on the base member B. In contrast, in the present exemplary embodiment, the light source unit 40 is provided on the base member B. Thus, it is possible to make the base member B smaller in the present exemplary embodiment than in the above exemplary embodiments. As a result, it is possible to make the entirety of the light source device smaller, which is desirable.

As described in the present exemplary embodiment, the number of light source units may not be two as in the first to third exemplary embodiments. The exemplary embodiments are common in that the light source units (the first light source unit 1 and the second light source unit 2, or the light source unit 40) emit both first blue light to be incident on the diffuser layer 9C and second blue light to be incident on the phosphor layer 9B.

### Variations

As described above, the rotating wheel 9 included in the light source device according to each of the above exemplary embodiments includes the rotating plate 9A made of a metal such as aluminum, and the diffuser layer 9C and the phosphor layer 9B that are provided at different positions from each other on the rotating plate 9A. The rotating wheel 9, however, is not limited to such a configuration. For example, the rotating wheel 9 may have a configuration in which the rotating wheel 9 includes a transparent rotating plate, the diffuser layer 9C, and the phosphor layer 9B, and reflective coating is applied to the entirety of the rotating plate or a portion where the diffuser layer 9C and the phosphor layer 9B are provided. That is, the rotating plate included in the rotating wheel 9 only needs to be configured to reflect light incident on the diffuser layer 9C and the phosphor layer 9B.

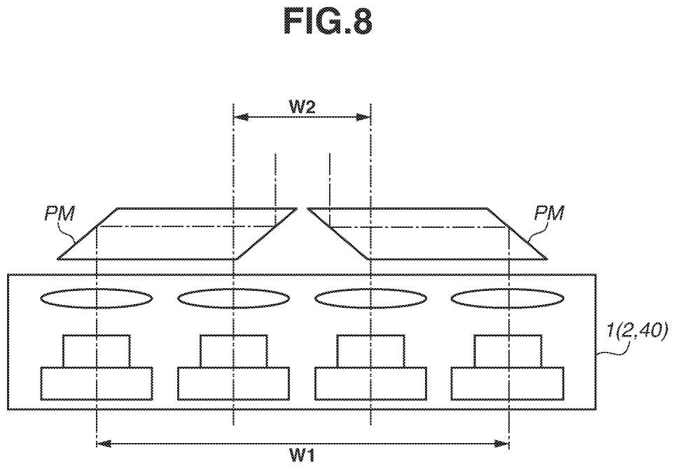

An optical element different from the optical elements illustrated in the figures may be provided on the optical path from each of the above light source units to the rotating wheel 9. For example, prism mirrors PM illustrated in FIG. 8 may be provided immediately after light source units, thereby reducing a width W1 of light from the light source units to a width W2. Instead of the prism mirrors PM, a lens of a size capable of letting in light from blue LDs of the light source units may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-120359, filed Jun. 27, 2019, which is hereby incorporated by reference herein in its entirety.

What is claimed is:

1. A light source device that guides light to an illumination optical system for illuminating a light modulation element, the light source device comprising:
a light source unit configured to emit first blue light and second blue light;
a rotating wheel including a rotating plate in which a diffusion element on which the first blue light is incident and a wavelength conversion element on which the second blue light is incident are provided; and
a first condenser lens unit configured to guide the first blue light to the diffusion element,
wherein the rotating plate is configured to reflect light incident on the diffusion element and also reflect light incident on the wavelength conversion element, and
wherein the first condenser lens unit is configured so that the first blue light from the light source unit is incident on the diffusion element via a first area of the first condenser lens unit, and the light from the diffusion element is incident on a second area of the first condenser lens unit.

2. The light source device according to claim 1, further comprising:
a first mirror configured to guide the first blue light to the first area of the first condenser lens unit; and
a second mirror configured to guide the light from the second area of the first condenser lens unit to the illumination optical system.

3. The light source device according to claim 1,
wherein the second area of the first condenser lens unit is located on a rotation shaft side of the rotating wheel with respect to an optical axis of the first condenser lens unit, and
wherein the first area of the first condenser lens unit is located on an opposite side of the rotation shaft side of the rotating wheel with respect to the optical axis of the first condenser lens unit.

4. The light source device according to claim 1,
wherein the light source unit is provided on a base member, and
wherein the light source unit includes
a first light source unit configured to emit the first blue light, and
a second light source unit configured to emit the second blue light and located at a position different from that of the first light source unit on the base member.

5. The light source device according to claim 1, further comprising a separating unit configured to separate blue light from the light source unit into the first blue light and the second blue light.

6. The light source device according to claim 1,
wherein the first area of the first condenser lens unit is located on a rotation shaft side of the rotating wheel with respect to an optical axis of the first condenser lens unit, and
wherein the second area of the first condenser lens unit is located on an opposite side of the rotation shaft side of the rotating wheel with respect to the optical axis of the first condenser lens unit.

7. The light source device according to claim 6,
wherein the first blue light from the light source unit is incident on the first area of the first condenser lens unit not via a mirror, and
wherein the light from the diffusion element is guided to the illumination optical system via the second area of the first condenser lens unit and a mirror.

8. A light source device that guides light to an illumination optical system for illuminating a light modulation element, the light source device comprising:
a light source unit configured to emit first blue light and second blue light;
a rotating wheel including a rotating plate in which a diffusion element on which the first blue light is incident and a wavelength conversion element on which the second blue light is incident are provided; and
a first condenser lens unit configured to guide the first blue light to the diffusion element,
wherein the rotating plate is configured to reflect light incident on the diffusion element and also reflect light incident on the wavelength conversion element,
wherein the first condenser lens unit is placed so that an optical axis of the first condenser lens unit is at an angle to a normal to the rotating wheel, and
wherein the first blue light from the light source unit is incident on the diffusion element via the first condenser lens unit, and the light from the diffusion element is guided to the illumination optical system not via the first condenser lens unit.

9. The light source device according to claim 8, wherein 0.9≤θL/θi≤1.1 is satisfied, where the angle between the optical axis of the first condenser lens unit and the normal to the rotating wheel is θL, and an angle of incidence of light incident on the diffusion element from the first condenser lens unit is θi.

10. The light source device according to claim 8,
wherein the light source unit is provided on a base member, and
wherein the light source unit includes
a first light source unit configured to emit the first blue light, and
a second light source unit configured to emit the second blue light and located at a position different from that of the first light source unit on the base member.

11. The light source device according to claim 1,
wherein the diffusion element is an annular diffuser layer provided on the rotating plate,
wherein the wavelength conversion element is an annular phosphor layer provided on the rotating plate, and
wherein the diffuser layer and the phosphor layer are provided on concentric circles.

12. The light source device according to claim 1, further comprising:
a combining element configured to combine the light from the diffusion element and the light from the wavelength conversion element; and
an afocal lens unit provided on an optical path from the diffusion element to the combining element and configured to enlarge a diameter of light incident on the afocal lens unit.

13. The light source device according to claim 1, further comprising:
a first condenser lens unit configured to guide the first blue light to the diffusion element; and
a second condenser lens unit configured to guide the second blue light to the wavelength conversion element.

14. The light source device according to claim 13, wherein 1.2≤f1/f2≤10 is satisfied, where a focal length of the first condenser lens unit is f1, and a focal length of the second condenser lens unit is f2.

15. The light source device according to claim 14, wherein 2.0≤f1/f2≤6.0 is further satisfied.

16. The light source device according to claim 13, wherein 5°≤θi≤45° is satisfied, where an angle of incidence of light incident on the diffusion element from the first condenser lens unit is θi.

17. The light source device according to claim 16, wherein 10°≤θi≤30° is further satisfied.

18. The light source device according to claim 1, wherein 1°≤Φ≤30° is satisfied, where a diffusion angle of the diffusion element is Φ.

19. The light source device according to claim 18, wherein 1°≤Φ≤15° is further satisfied.

20. An image projection apparatus comprising:
the light source device according to claim 1;
a light modulation element; and
a lens holding unit configured to hold a projection lens configured to guide light from the light modulation element to a projection target surface.
